(19) United States
(12) Patent Application Publication
(10) Pub. No.: US 2019/0272426 A1
(43) Pub. Date: Sep. 5, 2019

(54) LOCALIZATION SYSTEM AND METHOD AND COMPUTER READABLE STORAGE MEDIUM

(71) Applicant: Wistron Corporation, New Taipei City (TW)

(72) Inventor: Wei Hao Huang, New Taipei City (TW)

(21) Appl. No.: 15/959,754

(22) Filed: Apr. 23, 2018

(30) Foreign Application Priority Data
Mar. 1, 2018 (TW) 107106771

(51) Int. Cl. G06K 9/00; G06N 99/00; G06K 9/62

(52) U.S. Cl. CPC G06K 9/00671; G06N 99/005; G06K 9/22; G06K 9/6256; G06K 9/6262

(57) ABSTRACT

A localization method includes capturing a current image by a mobile device; transferring the current image to a remote end; performing image recognition on the current image according to a stored model trained by machine learning at the remote end, the model being generated beforehand by machine learning according to environmental images and corresponding labels, thereby obtaining a corresponding recognized label that includes localization information; and transferring the recognized label to the mobile device.

### CROSS-REFERENCE TO RELATED APPLICATIONS

This application claims priority to Taiwan Patent Application No. 107106771, filed on Mar. 1, 2018, the entire contents of which are hereby expressly incorporated by reference.

### BACKGROUND OF THE INVENTION

### 1. Field of the Invention

The present invention generally relates to indoor localization system and method, and more particularly to localization system and method that perform image recognition based on machine learning.

### 2. Description of Related Art

A mobile device such as a smartphone commonly performs localization by global positioning system (GPS). However, as no GPS signal can be received indoors, indoor localization thus cannot be performed by GPS.

Indoor localization is usually carried out by installing transmitters and/or sensors inside a building. Nevertheless, the transmitter/sensors require periodic maintenance and calibration at substantive maintenance cost. Further, signals of the transmitters/sensors are subjected to attenuation, which decreases localization accuracy. Moreover, mobile devices of users using conventional indoor localization technique need be online connected. As each mobile device has different signal processing capability and different signal strength, recognition error may inevitably be made and accuracy may unavoidably be decreased.

A need has thus arisen to propose a novel localization mechanism for reducing cost and improving accuracy.

### SUMMARY OF THE INVENTION

In view of the foregoing, it is an object of the embodiment of the present invention to provide localization system and method that perform image recognition based on machine learning, particularly indoor localization system and method without transmitters/sensors, therefore substantially saving construction and maintenance costs and not being affected by strength and attenuation of signals.

According to one embodiment, a localization system includes a mobile device and an image recognition system. The mobile device includes an image capture device; and a mobile processor that activates the image capture device to capture a current image. The image recognition system includes a storage device that stores a model trained by machine learning, the model being generated beforehand by machine learning according to a plurality of environmental images and corresponding labels, and the label including localization information; and an image processor that receives the current image transferred via a network, the image processor performing image recognition on the current image according to the stored model, thereby obtaining a corresponding recognized label which is then transferred to the mobile device via the network.

### BRIEF DESCRIPTION OF THE DRAWINGS

FIG. 1 shows a system block diagram illustrating a localization system according to a first embodiment of the present invention;

FIG. 2 shows a flow diagram illustrating a localization method according to the first embodiment of the present invention;

FIG. 3 shows a system block diagram illustrating a localization system according to a second embodiment of the present invention;

FIG. 4 shows a flow diagram illustrating a localization method according to the second embodiment of the present invention;

FIG. 5 shows a system block diagram illustrating a machine learning system adaptable to generating a trained model; and

FIG. 6 shows a flow diagram illustrating a machine learning method adaptable to generating the trained model.

### DETAILED DESCRIPTION OF THE INVENTION

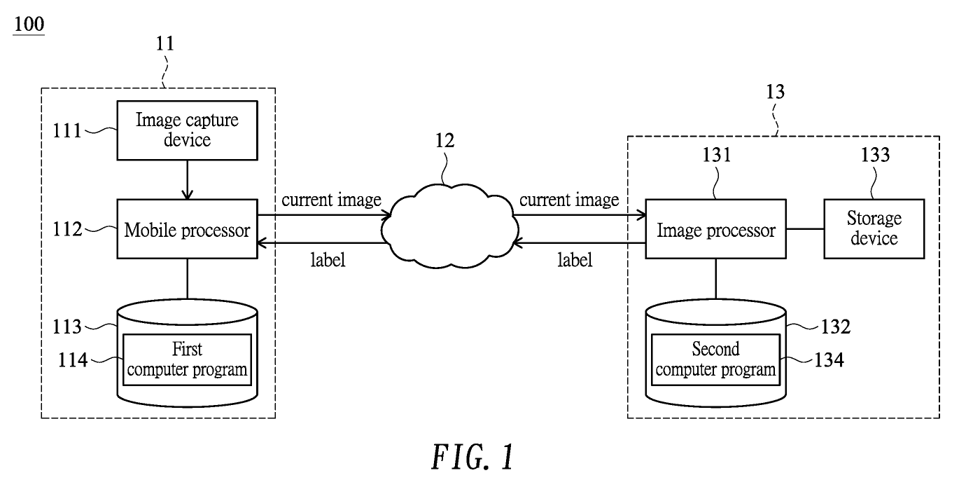

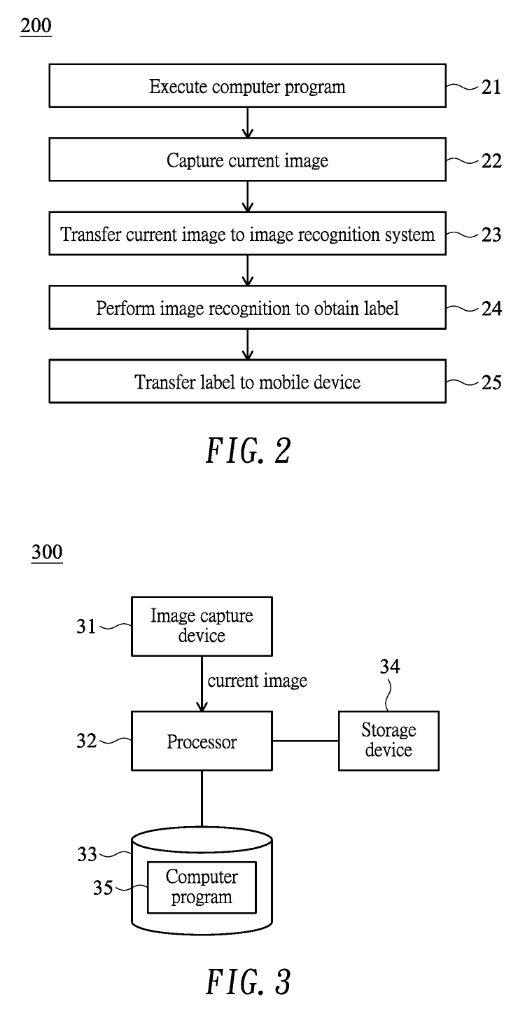

FIG. 1 shows a system block diagram illustrating a localization system 100 according to a first embodiment of the present invention, and FIG. 2 shows a flow diagram illustrating a localization method 200 according to the first embodiment of the present invention. The embodiment may be preferably adaptable to indoor localization, but may be applicable to outdoor localization.

In the embodiment, the localization system 100 may include a mobile device 11 such as, but not limited to, a smartphone. The mobile device 11 may include an image capture device 111, a mobile processor 112 and a first computer readable storage medium 113. Specifically, the first computer readable storage medium 113 may store a first computer program 114 such as a mobile application program (APP) designed to run on the mobile processor 112. The first computer readable storage medium 113 may include read-only memory (ROM), flash memory or other memory devices suitable for storing a computer program. The mobile processor 112 may include a central processing unit (CPU) configured to execute the first computer program 114 stored in the first computer readable storage medium 113. The image capture device 111 may include a camera. When a user executes the first computer program 114 (step 21) and inputs a destination name, the mobile processor 112 activates the image capture device 111 to capture a current image of (indoor) environment (step 22). The mobile processor 112 then transfers the captured current image to a (remote) image recognition system 13 via a network 12 such as the Internet (step 23).

The image recognition system 13 may be disposed at, but not limited to, a cloud. The image recognition system 13 may include an image processor 131, a second computer readable storage medium 132 and a storage device 133. Specifically, the image processor 131 may receive the current image transferred from the mobile device 11. The second computer readable storage medium 132 may store a second computer program 134 such as an image recognition application program designed to run on the image processor 131 to perform image recognition. The storage device 133 may store a model trained by machine learning, wherein the model is generated beforehand by machine learning according to environmental images and labels including corresponding localization information (e.g., coordinates, depth, a visual angle or information related to the environmental images). The second computer readable storage medium 132 and the storage device 133 may include read-only memory (ROM), flash memory or other memory devices suitable for storing a computer program or image data. Details of generating the model will be described later in the specification.

In step 24, the image processor 131 performs image recognition on the current image according to the model stored in the storage device 133, thereby obtaining a corresponding recognized label. The image recognition in step 24 may be performed by conventional image processing technique, details of which are omitted for brevity. Next, in step 25, the image processor 131 transfers the recognized label to the mobile processor 112 of the mobile device 11 via the network 12, and the mobile processor 112 then obtains coordinates and other information (e.g., depth and visual angle) of a location for guiding the user of the mobile device 11 according to the label. In one embodiment, the label obtained in step 24 contains real coordinates. In another embodiment, the label obtained in step 24 contains virtual coordinates, which need be transformed into real coordinates before transferring to the mobile device 11 or are transformed by the mobile device 11 after transferring to the mobile device 11.

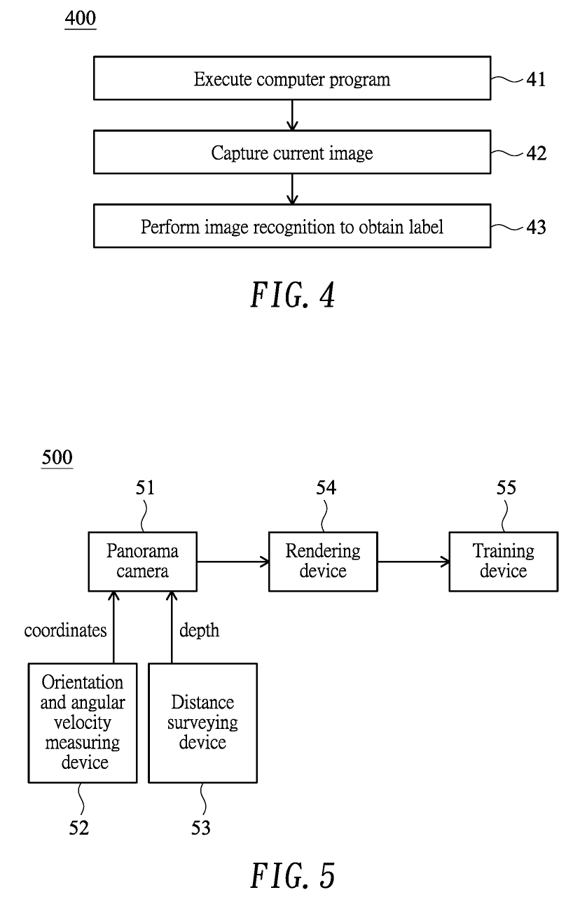

FIG. 3 shows a system block diagram illustrating a localization system 300 according to a second embodiment of the present invention, and FIG. 4 shows a flow diagram illustrating a localization method 400 according to the second embodiment of the present invention. The embodiment may be preferably adaptable to indoor localization, but may be applicable to outdoor localization.

In the embodiment, the localization system 300 may be disposed in a mobile device such as, but not limited to, a smartphone. The localization system 300 may include an image capture device 31, a processor 32, a computer readable storage medium 33 and a storage device 34. Specifically, the computer readable storage medium 33 may store a computer program 35 such as a mobile application program (APP) designed to run on the processor 32. The computer readable storage medium 33 may include read-only memory (ROM), flash memory or other memory devices suitable for storing a computer program. The image capture device 31 may include a camera. When a user executes the computer program 35 (step 41) and inputs a destination name, the processor 32 activates the image capture device 31 to capture a current image of (indoor) environment (step 42).

The storage device 34 may store a model trained by machine learning, wherein the model is generated beforehand by machine learning according to environmental images and labels including corresponding localization information (e.g., coordinates, depth, a visual angle or information related to the environmental images). The storage device 34 may include read-only memory (ROM), flash memory or other memory devices suitable for storing image data.

In step 43, the processor 32 performs image recognition on the current image according to the model stored in the storage device 34, thereby obtaining a corresponding recognized label. Coordinates and other information (e.g., depth and visual angle) of a location may be obtained for guiding the user of the localization system 300 (e.g., a mobile device) according to the label. In one embodiment, the label obtained in step 43 contains real coordinates. In another embodiment, the label obtained in step 43 contains virtual coordinates, which need be transformed into real coordinates.

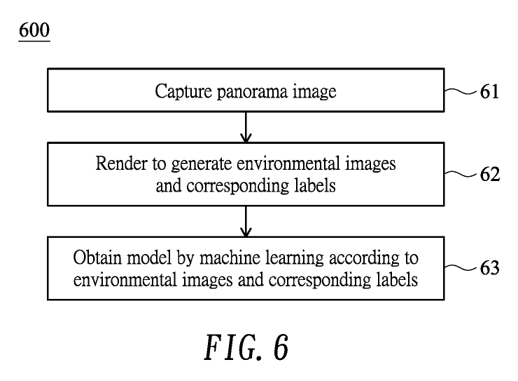

FIG. 5 shows a system block diagram illustrating a machine learning system 500 adaptable to generating a trained model for performing image recognition and (indoor) localization by the image processor 131 (FIG. 1) or the processor 32 (FIG. 3) according to one embodiment of the present invention. FIG. 6 shows a flow diagram illustrating a machine learning method 600 adaptable to generating the trained model for performing image recognition and (indoor) localization.

In the embodiment, the machine learning system 500 may include a panorama camera 51 configured to capture a panorama image (step 61). In one embodiment, the panorama camera 51 may include an omnidirectional camera such as virtual reality (VR)-360 camera with field of view (FOV) of 360 degrees such that images along all directions may be captured at the same time, thereby obtaining the panorama image. The omnidirectional camera may be composed of plural cameras, or may be a single camera with plural lenses. In another embodiment, multiple images are captured by a camera with limited FOV and are then composed to result in the panorama image.

While capturing the panorama image, corresponding coordinates may be obtained by an orientation and angular velocity measuring device 52 (e.g., gyroscope), and corresponding depth may be obtained by a distance surveying device 53 (e.g., light detection and ranging (Lidar).

The machine learning system 500 of the embodiment may include a rendering device 54 operatively receiving the capture panorama image and localization information (e.g., coordinates and depth), according to which (two-dimensional) environmental images and corresponding labels (e.g., localization information) with different angles may be generated (step 62). In another embodiment, real coordinates are obtained in step 61 and virtual coordinates are obtained in step 62, which possess coordinate transformation relationship therebetween. When one type of coordinates is known, the other type of coordinates may be obtained according to the coordinate transformation relationship.

The machine learning system 500 of the embodiment may include a training device 55 configured to obtain the model by machine learning according to the environmental images and corresponding labels (step 63). The trained model is then stored in the storage device 133 (FIG. 1) or the storage device 34 (FIG. 3) for performing image recognition by the image processor 131 (FIG. 1) or the processor 32 (FIG. 3). In one embodiment, the training device 55 may include a multi-level neural network, which repeatedly corrects the neural network and performs testing according to error between predicted results and real results, until accuracy conforms to an expected value, thereby obtaining the model.

Accordingly, compared to conventional indoor localization technique, the localization system and method of the embodiment need not install transmitters/sensors and therefore substantially save construction and maintenance costs. Moreover, the localization mechanism of the embodiment may not be affected by strength and attenuation of signals for lack of transmitters/sensors.

Although specific embodiments have been illustrated and described, it will be appreciated by those skilled in the art that various modifications may be made without departing from the scope of the present invention, which is intended to be limited solely by the appended claims.

What is claimed is:

1. A localization system, comprising:
a mobile device including:
an image capture device;
a mobile processor that activates the image capture device to capture a current image;
an image recognition system including:
a storage device that stores a model trained by machine learning, the model being generated beforehand by machine learning according to a plurality of environmental images and corresponding labels, and the label including localization information; and
an image processor that receives the current image transferred via a network, the image processor performing image recognition on the current image according to the stored model, thereby obtaining a corresponding recognized label which is then transferred to the mobile device via the network.

2. The localization system of claim 1, wherein the localization information comprises coordinates, depth or a visual angle.

3. The localization system of claim 1, further comprising:
a panorama camera that captures a panorama image and the localization information;
a rendering device that generates the environmental images and the corresponding labels according to the panorama image and the localization information; and
a training device that obtains the model by machine learning according to the environmental images and the corresponding labels.

4. The localization system of claim 3, wherein the panorama camera comprises an omnidirectional camera.

5. The localization system of claim 3, further comprising an orientation and angular velocity measuring device that obtains corresponding coordinates of the panorama image.

6. The localization system of claim 3, further comprising a distance surveying device that obtains corresponding depth of the panorama image.

7. A localization method, comprising:
capturing a current image by a mobile device;
transferring the current image to a remote end via a network;
performing image recognition on the current image according to a stored model trained by machine learning at the remote end, the model being generated beforehand by machine learning according to environmental images and corresponding labels, thereby obtaining a corresponding recognized label that includes localization information; and
transferring the recognized label to the mobile device via the network.

8. The method of claim 7, wherein the localization information comprises coordinates, depth or a visual angle.

9. The method of claim 7, further comprising:
capturing a panorama image and the localization information;
generating the environmental images and the corresponding labels according to the panorama image and the localization information; and
obtaining the model by machine learning according to the environmental images and the corresponding labels.

10. A computer readable storage medium storing a computer program that executes the following steps to perform localization:
capturing a current image;
transferring the current image to an image recognition system at a remote end via a network, the image recognition system performing image recognition on the current image according to a stored model trained by machine learning, the model being generated beforehand by machine learning according to environmental images and corresponding labels, thereby obtaining a corresponding recognized label that includes localization information; and
receiving the recognized label via the network.

11. The computer readable storage medium of claim 10, wherein the localization information comprises coordinates, depth or a visual angle.

12. A localization system, comprising:
an image capture device;
a processor that activates the image capture device to capture a current image; and
a storage device that stores a model trained by machine learning, the model being generated beforehand by machine learning according to a plurality of environmental images and corresponding labels, and the label including localization information;
wherein the processor performs image recognition on the current image according to the stored model, thereby obtaining a corresponding recognized label.

13. The localization system of claim 12, wherein the localization information comprises coordinates, depth or a visual angle.

14. The localization system of claim 12, further comprising:
a panorama camera that captures a panorama image and the localization information;
a rendering device that generates the environmental images and the corresponding labels according to the panorama image and the localization information; and
a training device that obtains the model by machine learning according to the environmental images and the corresponding labels.

15. The localization system of claim 14, wherein the panorama camera comprises an omnidirectional camera.

16. A localization method, comprising:
capturing a current image; and
performing image recognition on the current image according to a stored model trained by machine learning, the model being generated beforehand by machine learning according to environmental images and corresponding labels, thereby obtaining a corresponding recognized label that includes localization information.

17. The method of claim 16, wherein the localization information comprises coordinates, depth or a visual angle.

18. The method of claim 16, further comprising:
capturing a panorama image and the localization information;
generating the environmental images and the corresponding labels according to the panorama image and the localization information; and
obtaining the model by machine learning according to the environmental images and the corresponding labels.

19. A computer readable storage medium storing a computer program that executes the following steps to perform localization:
capturing a current image; and
performing image recognition on the current image according to a stored model trained by machine learning, the model being generated beforehand by machine learning according to environmental images and corresponding labels, thereby obtaining a corresponding recognized label that includes localization information.

20. The computer readable storage medium of claim 19, wherein the localization information comprises coordinates, depth or a visual angle.
